(19) United States
(12) Patent Application Publication
(10) Pub. No.: US 2019/0009734 A1
(43) Pub. Date: Jan. 10, 2019

(54) SUPPORT DEVICE AND METHOD

(71) Applicant: Juanda Smith-Hayes, Puyallup, WA (US)

(72) Inventor: Juanda Smith-Hayes, Puyallup, WA (US)

(21) Appl. No.: 16/030,589

(22) Filed: Jul. 9, 2018

Related U.S. Application Data
(60) Provisional application No. 62/529,687, filed on Jul. 7, 2017.

(51) Int. Cl. B60R 11/00

(52) U.S. Cl. CPC B60R 11/00; B60R 2001/1292; B60R 2011/0071; B60R 2011/0033

(57) ABSTRACT

A support device is disclosed herein. The support device includes a closed ribbon, a plurality of loops extending from a first surface of the ribbon, and a retention strap secured to the first surface of the ribbon and alternatively to another surface of the ribbon. The support device is useful for providing a place to hold and store accessories from a rear-view mirror of a vehicle.

### CROSS-REFERENCE TO RELATED APPLICATION(S)

The present application is related to and claims priority to U.S. Provisional Patent Application No. 62/529,687 filed Jul. 7, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of accessory holders of existing art and more specifically relates to an accessory support device for a rear-view mirror of a vehicle.

### RELATED ART

Eyewear also known as spectacles, sunglasses, or eyeglasses are devices with lenses mounted in a frame that are held in front of a user's eyes, typically using a bridge over the nose and temples which rest over the ears. Eyewear are typically used for vision correction or protection against the brightness and harmful rays of the sun.

Users typically utilize eyewear when driving a vehicle in order to improve their vision from the sun or provide enhancement to the eyes of the user. Often, users place their eyewear on available surfaces of the vehicle when not in use. This may allow eyewear to slide back and forth on a dashboard or console area. The eyewear can easily get thrown to the floor of the vehicle and out of reach of the user. Further, expensive eyewear can get scratched, smashed, or lost when left unsecured inside the vehicle. Therefore, a suitable solution is desired.

U.S. Pub. No. 2014/0043582 to Mike Paydar relates to an eyeglasses hanger. The described eyeglasses hanger includes a ring sized to receive a temple of eyeglasses so that the eyeglasses can hang from the ring. The ring is mounted on a structure that is configured to attach to various articles such as clothing, a metal surface or the rear view mirror of a car.

### SUMMARY OF THE INVENTION

In view of the foregoing disadvantages inherent in the known accessory holder art, the present disclosure provides a novel support device and method. The general purpose of the present disclosure, which will be described subsequently in greater detail, is to provide a support device and method to improve the hanging of eyewear or other accessories from a rear-view mirror of a vehicle.

A support device is disclosed herein. The support device includes a closed ribbon, a plurality of loops extending from a first surface of the ribbon, and a retention strap secured to the first surface of the ribbon and alternatively to another surface of the ribbon. The retention strap may be configured to retain the ribbon on a hanger, and the plurality of loops may be configured to receive accessories, such as eyewear.

According to another embodiment, a method for using a support device is also disclosed herein. The method includes providing a support device as described above; retaining the retention strap to the hanger; and receiving accessories in the plurality of loops.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a support device and method, constructed and operative according to the teachings of the present disclosure.

FIG. 1 is a perspective view of the support device during an ‘in-use’ condition, according to an embodiment of the disclosure.

FIG. 2 is a perspective view of the support device of FIG. 1, according to an embodiment of the present disclosure.

FIG. 3 is a front view of the support device of FIG. 1, according to an embodiment of the present disclosure.

FIG. 4 is a perspective view of the support device of FIG. 1, according to an embodiment of the present disclosure.

FIG. 5 is a flow diagram illustrating a method using a support device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to accessory holders and more particularly to a support device and method to improve hanging of eyewear or other accessories from a rear-view mirror of a vehicle.

Generally, eyewear or sunglasses are a form of protective lenses designed primarily to prevent bright sunlight and high-energy visible light from damaging or discomforting the eyes. They can sometimes also function as a visual aid, as variously termed spectacles or glasses exist, featuring lenses that are colored, polarized or darkened. Eyewear may be highly recommended especially if the eyes have been dilated for examination by an optometrist.

The present disclosure provides a support device that may be hung from the rear-view mirror of the vehicle as a way to secure eyewear. The support device holds and stores multiple pairs of eyeglasses or sunglasses for the user or vehicle occupants. The support device may prevent loose eyewear from moving around inside the cabin thereby preventing damage to the eyewear and providing accessibility of the eyewear to the user. The present disclosure may further accommodate reading glasses, sunglasses, and safety glasses of various sizes and lengths.

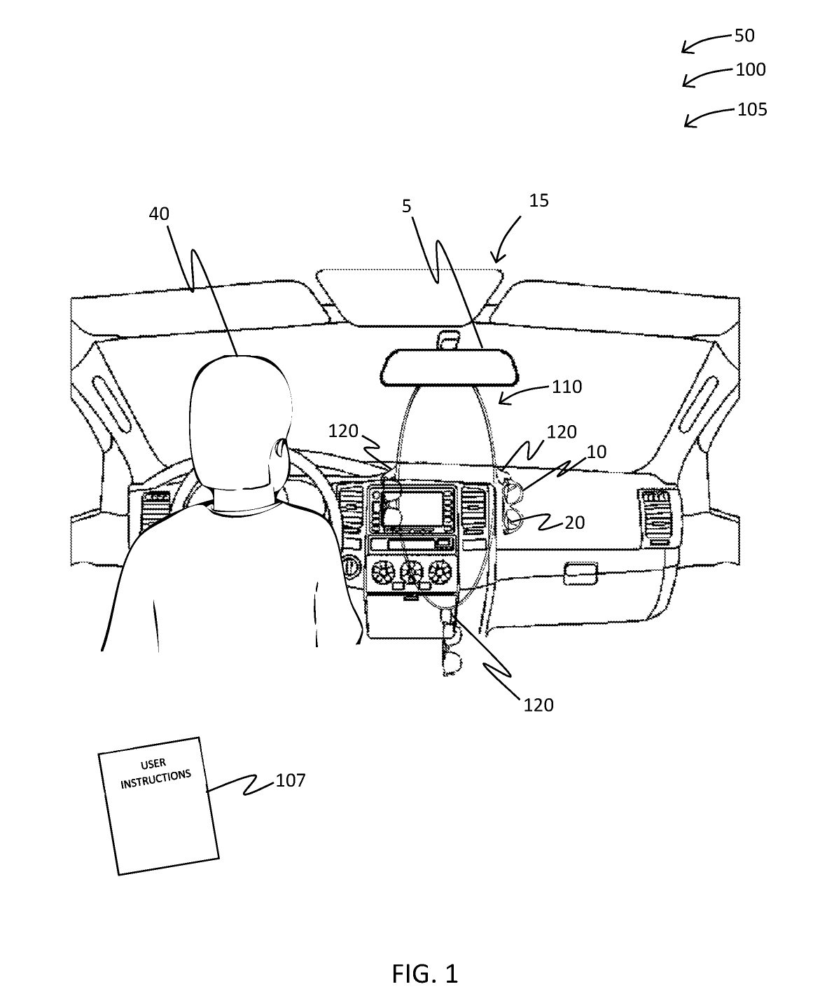

Referring now more specifically to the drawings by numerals of reference, there is shown in FIGS. 1-4, various views of a support device 100.

FIG. 1 shows a support device 100 during an ‘in-use’ condition 50, according to an embodiment of the present disclosure. Here, the support device 100 may be beneficial for use by a user 40 to hold and store eyewear or other accessories 10 from a desirable hanger 5. As illustrated, the support device 100 may include a closed ribbon 110, a plurality of loops 120 extending from a first surface 112 of the ribbon 110, and a retention strap 130 secured to the first surface 112 of the ribbon 110 and alternatively to another surface of the ribbon 110.

The retention strap 130 may be configured to retain the ribbon 110 on the hanger 5, and the plurality of loops 120 may be configured to receive the accessories 10. The accessories 10 may include eyewear or other such articles. The plurality of loops 120 may include a size (i.e. at least 1 inch in diameter) for receiving a temple 20 of the eyewear, such that the eyewear suitably hangs from the plurality of loops 120.

In a preferred embodiment, the hanger 5 may include a rear-view mirror typically found inside a vehicle 15. The support device 100 may be comprised of a non-rigid material such that it may suitably be stored or hung from the rear-view mirror. Examples of non-rigid materials include a fabric material or an elastic synthetic polymer.

According to one embodiment, the support device 100 may be arranged as a kit 105. In particular, the support device 100 may further include a set of instructions 107. The instructions 107 may detail functional relationships in relation to the structure of the support device 100 such that the support device 100 can be used, maintained, or the like, in a preferred manner.

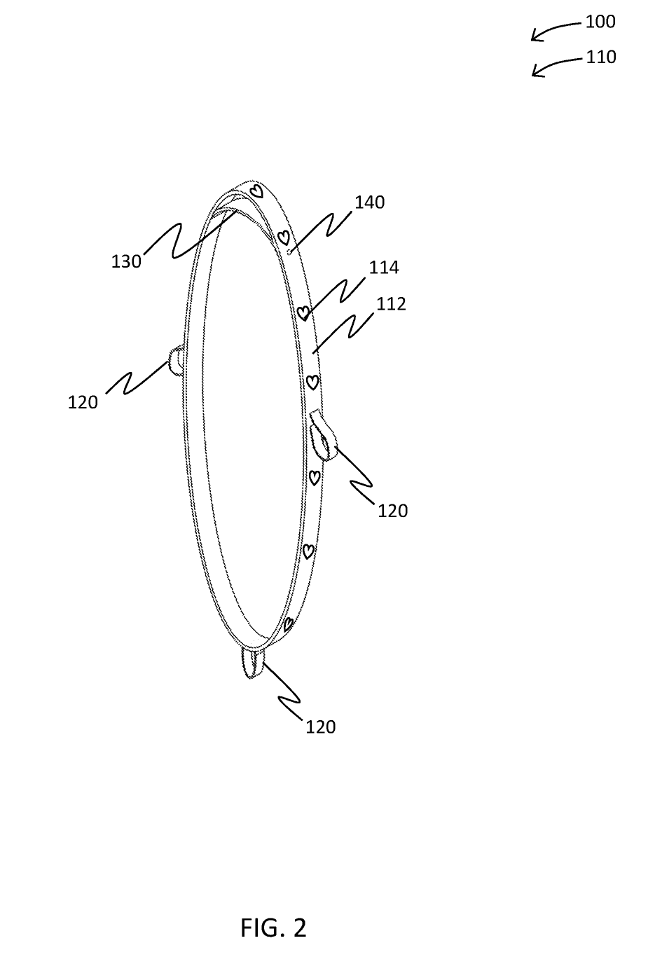

FIG. 2 shows the support device 100 of FIG. 1, according to an embodiment of the present disclosure. As above, the support device 100 may include the closed ribbon 110, the plurality of loops 120 extending from the first surface 112 of the ribbon 110, and the retention strap 130 secured to the first surface 112 of the ribbon 110 and alternatively to another surface of the ribbon 110. The support device 100 may include elongated and substantially-flat surfaces. In one embodiment, the surfaces, such as the first surface 112, may include a decorative-design pattern (i.e. hearts) 114, as shown. Further, a variety of colors may be contemplated.

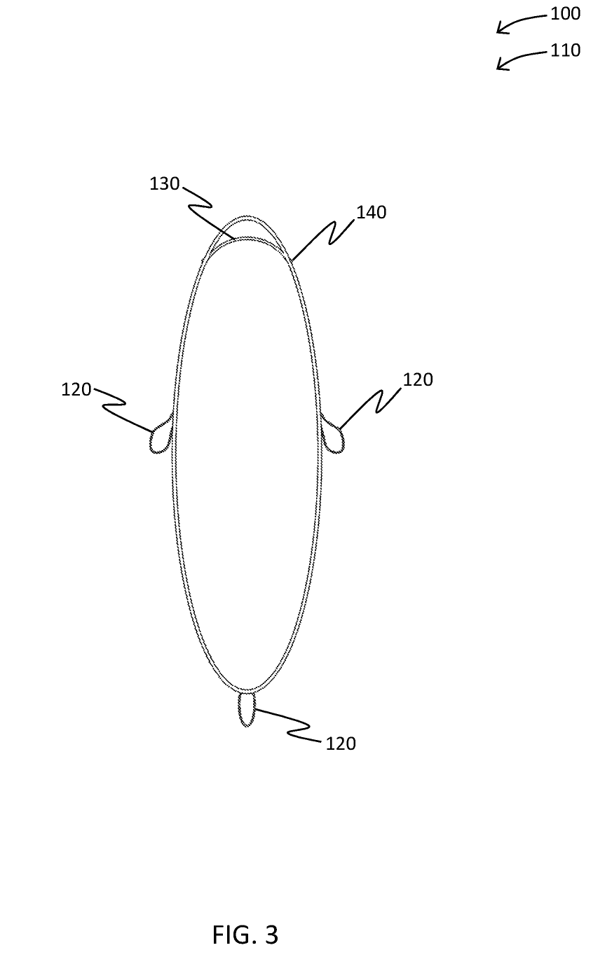

FIG. 3 is a front view of the support device 100 of FIG. 1, according to an embodiment of the present disclosure. The plurality of loops 120 may comprise at least three loops for hanging the accessories 10 therefrom. The plurality of loops 120 may preferably be arranged in a predetermined distance of each other such that the accessories 10 do not interfere with each other and are individually located. In addition, the plurality of loops 120 may be positioned below the retention strap 130.

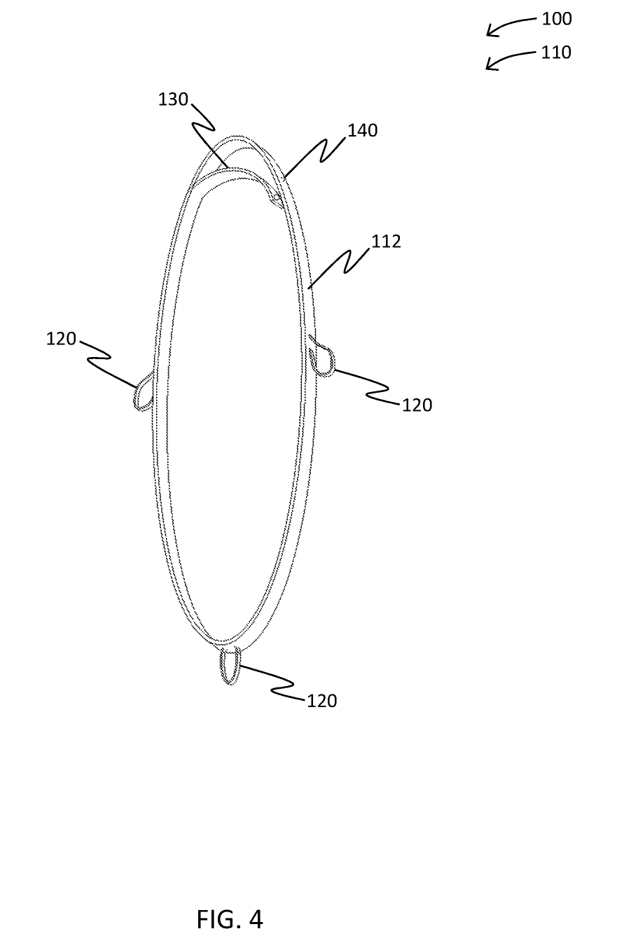

FIG. 4 is a perspective view of the support device 100 of FIG. 1, according to an embodiment of the present disclosure. In some embodiments, the retention strap 130 may be used to retain the ribbon 110 on the hanger 5 (FIG. 1). The retention strap 130 may be removably secured to the first surface 112 of the ribbon 110 via a fastener 140. In a preferred embodiment, the fastener 140 is a hook and loop fastener. However, other fastening means are contemplated and may be selected from a group consisting of a hook and eye fastener and a snap fastener.

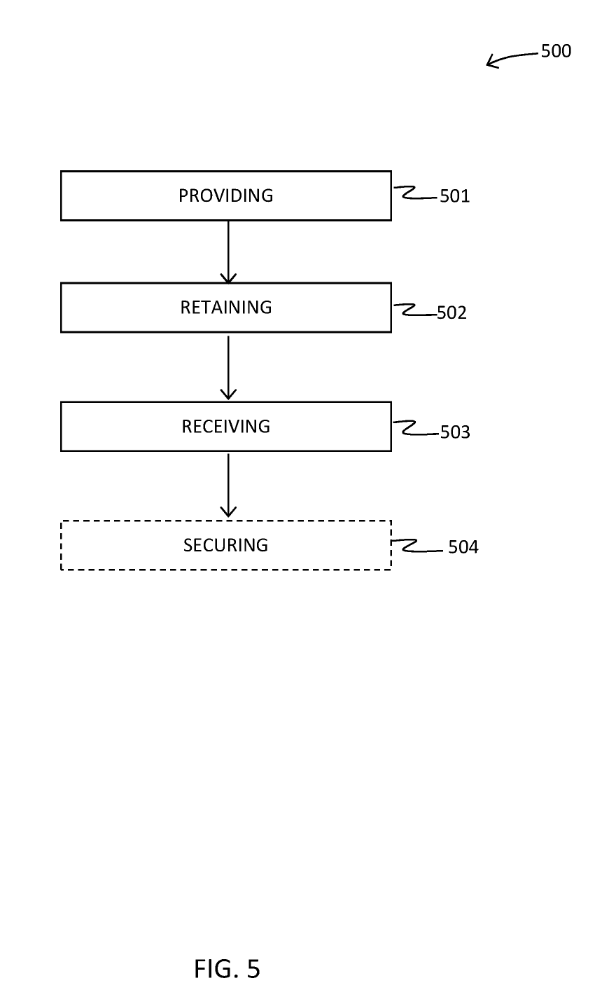

FIG. 5 is a flow diagram illustrating a method for using a support device 500, according to an embodiment of the present disclosure. In particular, the method 500 for using the support device may include one or more components or features of the support device 100 as described above. As illustrated, the method 500 for using the support device may include the steps of: step one 501, providing a support device 100 comprising a closed ribbon 110, a plurality of loops 120 extending from a first surface 112 of the ribbon 110, and a retention strap 130 secured to the first surface 112 of the ribbon 110 and alternatively to another surface of the ribbon 110; step two 502, retaining the retention strap 130 to a hanger 5; step three 503, receiving accessories 10 in the plurality of loops 120; and step four 504, securing the retention strap 130 to the first surface 112 via a fastener 140.

It should be noted that step four 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the support device 100, are taught herein.

Those with ordinary skill in the art will now appreciate that upon reading this specification and by their understanding the art of hangers as described herein, methods of retaining the support device 100 on other hangers in lieu of the rear-view mirror will be understood by those knowledgeable in such art.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A support device comprising:
a closed ribbon;
a plurality of loops extending from a first surface of the ribbon; and
a retention strap secured to the first surface of the ribbon and alternatively to another surface of the ribbon,
wherein the retention strap is configured to retain the ribbon on a hanger, and
wherein the plurality of loops is configured to receive accessories.

2. The support device of claim 1, wherein the support device is comprised of a non-rigid material.

3. The support device of claim 2, wherein the support device is comprised of a fabric material.

4. The support device of claim 2, wherein the support device is comprised of an elastic synthetic polymer.

5. The support device of claim 1, wherein the plurality of loops comprise at least three loops.

6. The support device of claim 1, wherein the plurality of loops are arranged in a predetermined distance of each other.

7. The support device of claim 1, wherein the plurality of loops are positioned below the retention strap.

8. The support device of claim 1, wherein the accessories include eyewear.

9. The support device of claim 8, wherein the plurality of loops include a size for receiving a temple of the eyewear, such that the eyewear hangs from the plurality of loops.

10. The support device of claim 1, wherein the hanger is a rear-view mirror.

11. The support device of claim 1, wherein the retention strap is removably secured to the first surface of the ribbon via a fastener.

12. The support device of claim 11, wherein the fastener is a snap fastener.

13. The support device of claim 11, wherein the fastener is a hook and eye fastener.

14. The support device of claim 11, wherein the fastener is a hook and loop fastener.

15. The support device of claim 1, wherein the support device includes elongated and substantially-flat surfaces.

16. The support device of claim 15, wherein the surfaces include a decorative-design pattern.

17. A support device comprising:
a closed ribbon;
a plurality of loops extending from a first surface of the ribbon; and
a retention strap secured to the first surface of the ribbon and alternatively to another surface of the ribbon,
wherein the retention strap is configured to retain the ribbon on a hanger,
wherein the plurality of loops is configured to receive accessories;
wherein the support device is comprised of a non-rigid material;
wherein the support device is comprised of an elastic synthetic polymer;
wherein the plurality of loops comprise at least three loops;
wherein the plurality of loops are arranged in a predetermined distance of each other;
wherein the plurality of loops are positioned below the retention strap;
wherein the accessories include eyewear;
wherein the plurality of loops include a size for receiving a temple of the eyewear, such that the eyewear hangs from the plurality of loops;
wherein the hanger is a rear-view mirror;
wherein the retention strap is removably secured to the first surface of the ribbon via a fastener;
wherein the fastener is a hook and loop fastener;
wherein the support device includes elongated and substantially-flat surfaces; and
wherein the surfaces include a decorative-design pattern.

18. The support device of claim 17, further comprising set of instructions; and
wherein the support device is arranged as a kit.

19. A method of using a support device, the method comprising the steps of:
providing a support device comprising a closed ribbon, a plurality of loops extending from a first surface of the ribbon, and a retention strap secured to the first surface of the ribbon and alternatively to another surface of the ribbon,
retaining the retention strap to a hanger, and
receiving accessories in the plurality of loops.

20. The method of claim 19, further comprising the steps of
securing the retention strap to the first surface via a fastener.
